(19) United States
(12) Patent Application Publication
(10) Pub. No.: US 2015/0019709 A1
(43) Pub. Date: Jan. 15, 2015

(54) METHOD AND APPARATUS FOR CONTROLLING INITIATION OF MULTI-SERVICE TRANSACTIONS

(71) Applicant: APOLLO GROUP, INC., PHOENIX, AZ (US)

(72) Inventors: SAJITHKUMAR KIZHAKKINIYIL, Pleasanton, CA (US); Jeevan Pingali, Bangalore (IN); Sitakanta Hotta, Bangalore (IN); Rahul Kumar, Bangalore (IN); Shridhar Navanageri, Sunnyvale, CA (US); Narender Vattikonda, San Jose, CA (US)

(21) Appl. No.: 13/939,077

(22) Filed: Jul. 10, 2013

(51) Int. Cl. H04L 12/26

(52) U.S. Cl. CPC H04L 43/04
USPC 709/224

(57) ABSTRACT

A method and apparatus are disclosed for controlling multi-service transactions. When a request to initiate a multi-service transaction is received, the transaction is not immediately initiated. Rather, a determination is first made as to which services need to be invoked in order to complete the transaction. A further determination is then made as to whether at least one of the services is likely to be unable to complete processing needed to further the transaction to completion. If at least one of the services is likely to be unable to complete processing needed to further the transaction to completion (thereby meaning that the overall transaction is likely to fail), then the transaction is not initiated at all. By doing so, the method/apparatus prevents transactions that are likely to fail from being started, which prevents waste of resources and other problems associated with partial processing of failed transactions from arising.

### FIELD OF THE INVENTION

The present invention relates generally to transaction processing and more particularly to a method and apparatus for controlling the initiation of transactions that involve multiple services.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

Many of today's online computing functionalities are provided by services that are implemented in a service-oriented architecture. As used herein, the term service refers broadly to any computing resource that can be invoked to provide one or more functionalities. A service may, for example, take the form of an application, a process, an applet, a servlet, etc. Services are often hosted on distributed computing nodes. For example, a first set of services may be hosted on a first computing node, a second set of services may be hosted on a second computing node, and a third set of services may be hosted on a third computing node. Services typically operate autonomously. That is, the operation of a service usually does not depend on the operation of another service, and any service may generally invoke any other service on the same or different computing node. The interaction between services is typically not coordinated by any overseeing entity. This lack of coordination provides great flexibility and versatility in the manner in which services can interact with each other and in the way that services can be used.

Multiple services may be invoked to carry out larger scale transactions. For example, to carry out a transaction to purchase an item from an online retailer, a browsing service may be invoked to enable a user to browse through items that are available for sale, an ordering service may be invoked to allow the user to order an item, and a payment service may be invoked to enable the user to pay for the item. The services that are part of a transaction may invoke other services that are part of the transaction in order to further the transaction. In order for the entire transaction to complete, all of the services in the transaction need to complete their portion of the processing successfully. If any of the services are unable to do their part, then the overall transaction fails.

As noted previously, the interaction between services is typically not coordinated by any overseeing entity. While this provides flexibility and versatility, it may also lead to significant inefficiency and other issues when it comes to handling transactions that involve multiple services. For example, suppose a transaction requires the invocation of a first service, a second service, a third service, and a fourth service, in that order. Suppose further that the first three services are able to perform the necessary processing but the fourth service fails during processing. In such a case, the overall transaction fails, which means that all of the work done by the first three services is for naught; hence, all of the resources consumed by the first three services in carrying out the transaction are wasted. Worse yet, the first three services may need to consume even more resources to rollback or undo the results of processing the failed transaction. As an additional drawback, user dissatisfaction or frustration may result from the fact that the user wasted time and effort in conducting a transaction that failed near the end.

Thus, as shown by the above discussion, the current methodology for handling transactions that involve multiple services has significant drawbacks. Hence, an improved methodology is needed.

### BRIEF DESCRIPTION OF THE DRAWINGS

FIG. 1 is a functional block diagram of a system in which one embodiment of the present invention may be implemented.

FIG. 2 is a flow diagram illustrating how initiation of multi-service transactions may be controlled, in accordance with one embodiment of the present invention.

FIG. 3 is a block diagram of a sample computer system that may be used to implement at least a portion of the present invention.

### DETAILED DESCRIPTION OF EMBODIMENT(S)

### Overview

In accordance with one embodiment of the present invention, an improved method is provided for controlling the initiation of transactions that involve multiple services. With this improved method, many of the current problems pertaining to multi-service transactions can be eliminated.

Specifically, in one embodiment, when a request to initiate a multi-service transaction is received, the transaction is not immediately initiated. Rather, a determination is first made as to which services need to be invoked in order to complete the transaction. A further determination is then made as to whether at least one of the services is likely to be unable to complete processing needed to further the transaction to completion. If it is determined that at least one of the services is likely to be unable to complete processing needed to further the transaction to completion (thereby meaning that the overall transaction is likely to fail), then the transaction is not initiated at all. By doing so, the method prevents transactions that are likely to fail from being started, which prevents waste of resources and other problems associated with partial processing of failed transactions from arising.

In one embodiment, to determine which services need to be invoked in order to complete a transaction, a transaction type identifier may be extracted from the transaction request. A set of transaction information, which indicates which services are associated with which transaction type identifiers, may then be accessed. The set of transaction information may be provided by a user or may be dynamically generated as transactions are processed (as will be described in a later section). From the transaction information, a set of services associated with the transaction type identifier of the transaction request may be obtained. This set of services represents the services that need to be invoked in order to complete the requested transaction.

In one embodiment, to determine whether at least one of the services is likely to be unable to complete processing needed to further the transaction to completion, a set of health information pertaining to the services may be consulted. If the health information indicates that any of the services is currently unavailable (e.g. has crashed or is currently offline), then it is quite likely that the transaction will not be able to complete successfully. In such a case, the transaction is not initiated.

In some cases, one (or more) of the services may be available, but may exhibit symptoms that it is likely to fail when called upon to perform processing for the transaction (these symptoms may be evident through the health information). In such a case, the method may predictively conclude that the service is likely to fail during transaction processing (and hence, the overall transaction is likely to fail), and thus cause the transaction to not be initiated. By not initiating transactions that are likely to fail, the present method improves overall system efficiency, and prevents other problems associated with partially processing transactions from arising.

### Sample System

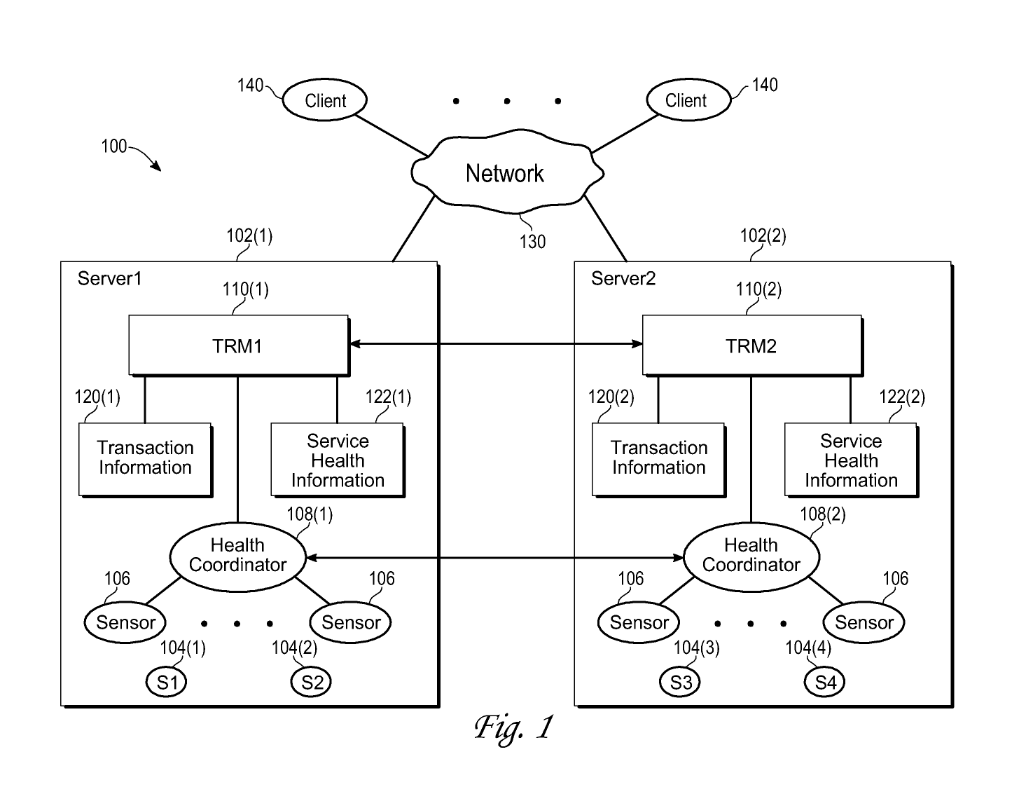

With reference to FIG. 1, there is shown a functional block diagram of a system 100 in which one embodiment of the present invention may be implemented. As shown, system 100 comprises a first server 102(1) (Server1) and a second server 102(2) (Server2). For referencing purposes, similar elements will be referenced using the same reference number. For example, the reference number 102 is used for both of the servers. This reference number will be used when referring to a server generally. When it is desired to refer to a specific server, then an additional index will be used. For example, when referring to Server2, the reference number 102(2) will be used. This convention will be used for the other elements as well.

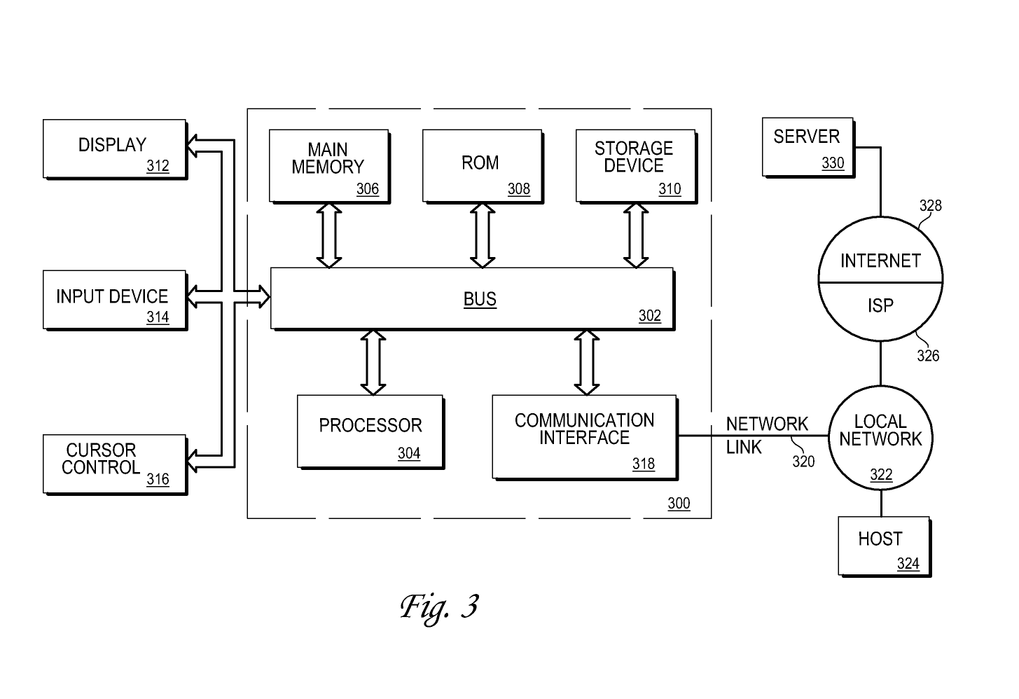

In one embodiment, Server1 102(1) and Server2 102(2) may be implemented using any type of computer system, such as the sample computer system shown in FIG. 3, which will be described in a later section. Server1 102(1) hosts two services: service S1 104(1) and service S2 104(2). Server2 102(2) also hosts two services: service S3 104(3) and service S4 104(4). For purposes of the present invention, services S1-S4 may take on any form (e.g. application, process, applet, servlet, or any other resource that can be invoked), and may provide any desired functionalities. In one embodiment, the services S1-S4 may operate autonomously (that is, the operation of each service is not dependent on the operation of any other service), and each service 104 may invoke another service 104 on the same or different server 102 as part of carrying out a transaction. It should be noted that system 100 is shown for illustrative purposes only. As far as the present invention is concerned, system 100 need not comprise two servers 102, but rather may include any desired number of servers. Also, each server 102 need not host two services 104, but rather may host any number of services (or may host no services at all). All possible variations are within the scope of the present invention. To enable the servers 102(1), 102(2) to communicate with each other and with one or more clients 140, the servers 102(1), 102(2) may be coupled to a network 130. For purposes of the present invention, network 130 may be a local area network (LAN), a wide area network (WAN), such as the Internet, or any other type of network. The clients 140 may be users, automated processes, or any other type of entity that may invoke one or more services 140.

In one embodiment, each server 102 comprises one or more sensors 106. The sensors 106 on a server 102 may monitor various operational aspects of the services 104 that execute (or are hosted) on that server 102. In one embodiment, it is the sensors 106 that provide information indicating how healthy the services 104 are. For purposes of the present invention, a sensor 106 may be implemented as a hardware component or as a software component that executes on a server 102. In sample system 100, the sensors 106 on Server1 102(1) monitor various operational aspects of service S1 104(1) and service S2 104(2). The sensors 106 on Server2 102(2) monitor various operational aspects of service S3 104(3) and service S4 104(4). For purposes of the present invention, the sensors 106 on a server 102 may monitor any desired operational aspects of any services 104 that execute on that server 102. The following are non-limiting examples of some of the operational aspects that may be monitored by the sensors 106.

For example, a sensor 106 may monitor the CPU usage of a server 102 to determine whether the CPU of the server 102 is in danger of being overtaxed. Also, a sensor 106 may monitor the memory usage and/or storage usage of the server 102 to determine whether the server 102 is nearing its memory and/or storage capacity. A sensor 106 may monitor the network connectivity of a server 102 or a service 104 to determine whether the server 102 or service 104 is able to effect communication on the network 130.

In addition to these general operational aspects of the services 104, the sensors 106 may also monitor operational aspects that are more service-specific. For example, for some services 104, a database (not shown) may be used to store and maintain information. For such services 104, a sensor 106 may monitor connectivity to the database to determine whether the service (or services) 104 is able to access the database. A sensor 106 may also monitor the pool of connections that are used to connect to the database to determine whether there are sufficient connections left in the pool to allow database access. A sensor 106 may also monitor the responses that are provided by a service 104 in response to service requests. If, for example, a service 104 has been sending error messages in response to service requests, then it may indicate that the service 104 is unhealthy. A sensor 106 may also monitor the response time (or turnaround time) of a service 104. If the response time is greater than a threshold, or is significantly longer than an average response time for the service 104, then it may be an indication that the service 104 is overloaded or even unhealthy. A sensor 106 may also monitor specific functionalities provided by a service 104. For example, if a service 104 provides three functionalities, a sensor 106 may monitor the performance of the service 104 with regard to each of the three functionalities. If, for example, two of the functionalities are working properly but the third functionality is providing error response messages or is responding slowly, then it may indicate that the service 104 is healthy for the first two functionalities but not for the third. As the above examples show, a sensor 106 may monitor the operational aspects of a service 104 at any desired granularity level, from a high overall level to a low level at which specific functionalities or even specific aspects of specific functionalities are monitored. For purposes of the present invention, any type and any level of monitoring may be performed by the sensors 106.

As a result of their monitoring activities, the sensors 106 generate many sets of sensor information. In one embodiment, the sensors 106 provide their sets of sensor information to a corresponding health coordinator 108. In sample system 100, Server1 102(1) has a health coordinator 108(1) executing thereon, and Server2 102(2) has a health coordinator 108(2) executing thereon. Thus, the sensors 106 on Server1 102(1) provide their sensor information to health coordinator 108(1), and the sensors 106 on Server2 102(2) provide their sensor information to health coordinator 108(2). In effect, the health coordinators 108(1), 108(2) act as sensor information collectors. In addition to receiving sensor information provided by the sensors 106, a health coordinator 108 may also query the sensors 106 for sensor information. To enable this sensor information exchange, the sensors 106 and health coordinators 108(1), 108(2) may implement an information exchange interface. Also, when a sensor 106 is added to a server 102, it is registered with the corresponding health coordinator 108 on that server 102. That way, the health coordinator 108 will be aware of the existence of the sensor 106, and will know to collect sensor information from that sensor 106 in the future. In sample system 100, the health coordinator 108(1) on Server1 102(1) collects sensor information for both S1 104(1) and S2 104(2), and the health coordinator 108(2) on Server2 102(2) collects health information for both S3 104(3) and S4 104(4). This is just one possible implementation. As an alternative, there may be a health coordinator 108 for each service 104. Thus, Server1 102(1) may have a health coordinator 108 that collects sensor information for S1 104(1) and another health coordinator 108 that collects sensor information for S2 104(2). Similarly, Server2 102(2) may have a health coordinator 108 that collects sensor information for S3 104(3) and another health coordinator 108 that collects sensor information for S4 104(4). This and other alternative implementations are within the scope of the present invention.

In one embodiment, in addition to collecting sensor information, the health coordinators 108(1), 108(2) may also disseminate sensor information. In particular, whenever a health coordinator 108 receives a set of sensor information from a sensor 106, it may broadcast that sensor information to other health coordinators 108. For example, whenever the health coordinator 108(1) on Server1 102(1) receives sensor information from the sensors on Server1 102(1), it may broadcast the sensor information to the health coordinator 108(2) on Server2 102(2). Similarly, whenever the health coordinator 108(2) on Server2 102(2) receives sensor information from the sensors on Server2 102(2), it may broadcast the sensor information to the health coordinator 108(1) on Server1 102(1). By doing so, the health coordinators 108 ensure that all of the health coordinators 108 in the system 100 have sensor information pertaining to all of the servers 102 and all of the services 104 in the system 100. In one embodiment, to enable this sensor information exchange, whenever a health coordinator 108 is added to a server 102 in system 100, it is registered with the other health coordinators 108 on the other servers 102 in the system 100. That way, all of the health coordinators 108 in system 100 will be aware of each other, and will know to exchange sensor information with each other. In FIG. 1, for the sake of illustration, a line is shown between health coordinator 108(1) and health coordinator 108(2) to indicate that the two health coordinators exchange sensor information. In practice, this communication is likely to be conducted over network 130 rather than via a direction connection.

In addition to providing sensor information to each other, the health coordinators 108(1), 108(2) may also provide sensor information to corresponding transaction request monitors (TRMs) 110. In sample system 100, Server1 102(1) has a TRM1 110(1) executing thereon, and Server2 102(2) has a TRM2 110(2) executing thereon. Thus, health coordinator 108(1) may provide sensor information to TRM1 110(1), and health coordinator 108(2) may provide sensor information to TRM2 110(2). The sensor information provided by a health coordinator 108 to a TRM 110 may include sensor information received from one or more sensors 106 as well as sensor information received from a fellow health coordinator 108. In addition to receiving sensor information provided by a health coordinator 108, a TRM 110 may also query a health coordinator 108 for sensor information. To enable this sensor information exchange, the health coordinators 108(1), 108(2) and the TRMs 110(1), 110(2) may implement an information exchange interface.

In one embodiment, it is the TRMs 110(1), 110(2) that control initiation of multi-service transactions, in accordance with the method disclosed herein. In performing this function, a TRM 110 relies on the sensor information provided by a corresponding health coordinator 108 to determine the health and availability of services 104. However, the sensor information provided by a health coordinator 108 may be quite raw, and the volume of the sensor information may be quite extensive; thus, the raw sensor information does not lend itself to being used during regular operation to make quick decisions on whether to initiate multi-service transactions. Thus, in one embodiment, the TRMs 110(1), 110(2) pre-process and pre-analyze the raw sensor information to generate a summarized or distilled set of service health information 122, and it is this service health information 122 that is used during regular operation to determine the health and availability of services 104. In sample system 100, TRM1 110(1) uses the raw sensor information from health coordinator 108(1) to generate service health information 122(1), and TRM2 110(2) uses the raw sensor information from health coordinator 108(2) to generate service health information 122(2). Since the sensor information received by both TRMs 110(1), 110(2) should be the same, the service health information 122(1), 122(2) generated by both TRMs 110(1), 110(2) should also be the same. It should be noted that this pre-processing and pre-analysis, although useful and desirable, is not required. If so desired, the raw sensor information may be used during regular operation to determine the health and availability of services 104 (in such a case, the raw sensor information would be used as the service health information 122). Also, the pre-processing and pre-analysis need not be performed by the TRMs 110(1), 110(2). Rather, it could be carried out by the health coordinators 108(1), 108(2) or some other component(s) not shown in FIG. 1. These and other alternatives are within the scope of the present invention.

In one embodiment, a TRM 110 pre-processes and pre-analyzes raw sensor information based upon a set of rules. These rules may be hardcoded into the TRM 110, or they may be specified, for example, in a configuration file, and processed by the TRM 110. The rules may govern, for example, which sets of sensor information are taken into account, what weight or level of importance is assigned to each set of sensor information, how the sets of sensor information are to be processed, what conclusions are to be drawn from the sensor information, etc. The rules may be service-specific so that different rules are applied to different services 104. For purposes of the present invention, the rules may cause the TRM 110 to process the sensor information in any desired manner, analyze the sensor information at any desired granularity level, and draw any desired conclusions at any desired granularity level. In one embodiment, under direction of the rules, the TRM 110 determines, based upon the sensor information, the current health and availability of each service 104, and generates information that can be used to determine whether a service 104 is likely to be unable to complete processing needed to further a transaction to completion. The results of the pre-processing and pre-analysis are stored into the service health information 122.

In one embodiment, the service health information 122 may include one or more sets of information for each service 104. This information may indicate, for example, whether a service is currently available at all (e.g. the service may have crashed, may have been taken offline, etc.). The information may also indicate an overall, high level assessment of the health of a service 104. Furthermore, the service health information 122 for a service 104 may include some lower granularity information for the service. For example, the information may indicate that a service is healthy for read operations but not for write or storage operations (this may be the case, for example, if the service 104 is overall healthy but the server 102 on which the service 104 is executing is low on memory or storage capacity). The information may also indicate that a service 104 is healthy for one or more of the functionalities that it provides but not for others (for example, if a service 104 provides three functionalities, the service health information 122 may indicate that the first two functionalities of the service 104 are healthy but the third functionality is not). The information may also indicate that a service is healthy so long as no database operations are to be performed (this may be the case, for example, if the service 104 is overall healthy but database connectivity is poor or the number of available connections in a connections pool is low). These and other types of information for a service 104 may be included in the service health information 122. For purposes of the present invention, any type and any granularity of information for a service 104 may be included in the service health information 122.

In performing its function of determining whether to initiate a multi-service transaction, a TRM 110 may use not only the service health information 122 but also a set of transaction information 120. In one embodiment, the transaction information 120 indicates which services are associated with which transaction type identifiers. In addition, the transaction information 120 may indicate an order in which the services associated with each transaction type identifier are to be invoked. As will be elaborated upon in a later section, the transaction information 120 may be used to determine which services need to be invoked in order to complete a transaction. The transaction information 120 may be specified/provided by a user. In addition to or in lieu of being provided by a user, the transaction information 120 may be augmented/generated by the TRMs 110 during the processing of transactions. This will be elaborated upon in a later section. For purposes of the present invention, the transaction information 120 may be stored in any desired form (e.g. as a plurality of ordered lists indexed by transaction type identifiers, as entries in one or more tables, etc.).

### Sample Operation

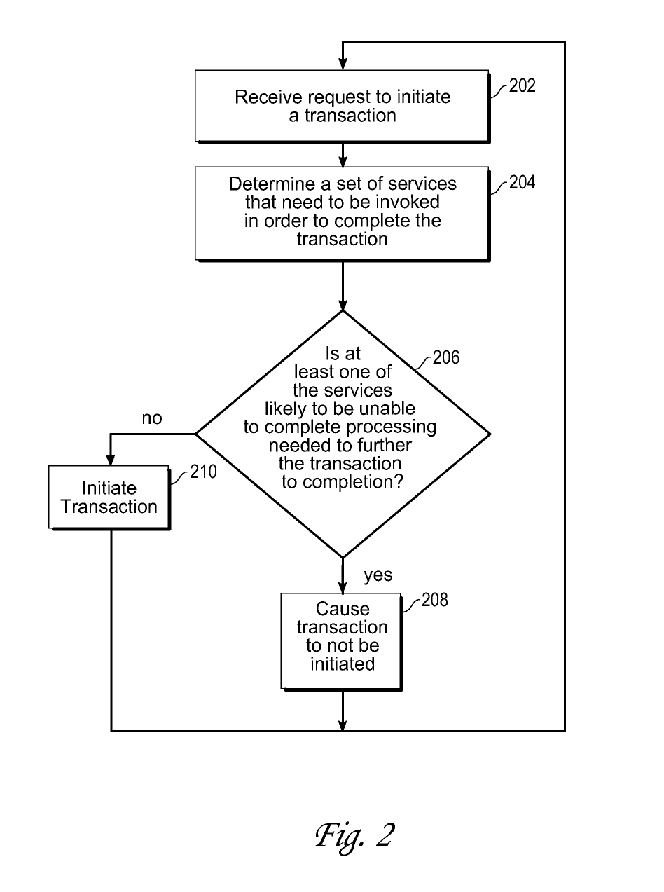

With the above sample system 100 in mind, a sample operation in accordance with one embodiment of the present invention will now be described with reference to the flow diagram shown in FIG. 2. In the following example, operation will be described from the perspective of TRM1 110(1) on Server1 102(1). It should be noted that TRM2 110(2) on Server2 102(2) may operate in a similar manner.

During regular operation, TRM1 110(1) may receive (block 202) from a client 140 over network 130 a request to initiate a transaction. Upon receiving the request, TRM1 110(1) may determine (block 204) what set of services need to be invoked in order to complete the requested transaction. In one embodiment, TRM1 110(1) may do so by: extracting a transaction type identifier from the request; accessing the transaction information 120(1); and using the transaction type identifier to obtain from the transaction information 120(1) a set of services that are associated with the transaction type identifier. This set of services represents the services that need to be invoked in order to complete the transaction requested in the transaction request. The transaction information 120(1) may indicate the order in which the services are to be invoked. For the sake of example, it will be assumed that the set of services that need to be invoked are services S1, S2, S3, and S4, and that they need to be invoked in the following order: S1; S2; S3; S4.

After the set of services is determined, TRM1 110(1) may proceed to determine (block 206) whether at least one of the services is likely to be unable to complete processing needed to further the transaction to completion. In one embodiment, TRM1 110(1) may make this determination in the following manner. Initially, TRM1 110(1) accesses, from heath service information 122(1), health information for the first service that is to be invoked, which in the current example is service S1 104(1). From this health information, TRM1 110(1) may determine whether S1104(1) is currently available at all. If S1 104(1) is not currently available (e.g. S1 may have crashed, may have been taken offline, etc.), then TRM1 110(1) may conclude that the overall transaction is likely to fail. As a result, TRM1 110(1) may proceed to cause (block 208) the transaction to not be initiated. In causing the transaction to not be initiated, TRM1 110(1) may prevent the transaction request from being forwarded to S1 104(1), and may send a message to the requesting client 140 indicating that the transaction cannot be performed at this time.

If, on the other hand, the health information for S1 104(1) indicates that S1 104(1) is currently available, then TRM1 110(1) may look deeper into the health information to determine whether S1 104(1) is likely to fail while performing processing for the requested transaction. For example, the health information may include an overall health indicator for S1 104(1). If this overall health indicator indicates that S1 104(1) is not healthy, then TRM1 110(1) may predictively conclude that S1 104(1) is likely to fail while performing processing for the requested transaction, which means that the overall transaction is likely to fail. Hence, TRM1 110(1) may proceed to cause (block 208) the transaction to not be initiated.

As a further example, the health information for S1 104(1) may be more granular. For example, the health information may indicate that S1 104(1) is healthy for read operations but not write or storage operations, or that S1 104(1) is healthy for one or more specific functionalities that it provides but not for one or more other functionalities that it provides, or that S1 104(1) is healthy so long as no database operations are to be performed, etc. TRM1 110(1) may use this more granular health information, along with additional information from the transaction request, to determine whether S1 104(1) is likely to fail while performing processing for the transaction. For example, the transaction request may include information indicating what processing is to be performed by S1 104(1) for the transaction (e.g. the transaction request may indicate whether a read or a write operation is to be performed, which functionality is to be invoked, whether a database operation is required, etc.). Using the granular health information, and the additional information from the transaction request, TRM1 110(1) may predictively determine whether S1 104(1) is likely to fail during transaction processing. For example, if the granular health information indicates that S1104(1) is healthy for read but not write or storage operations, and if the transaction request requires a write operation, then TRM1 110(1) may predictively conclude that S1 104(1) is likely to fail while performing processing for the transaction. Similarly, if the granular health information indicates that S1 104(1) is not healthy for a functionality X that S1 provides, and if the transaction request invokes functionality X, then TRM1 110(1) may predictively conclude that S1 104(1) is likely to fail while performing processing for the transaction. Likewise, if the granular health information indicates that S1 104(1) is healthy so long as no database operations are to be performed, and if the transaction request requires a database operation, then TRM1 110(1) may predictively conclude that S1 104(1) is likely to fail while performing processing for the transaction. In this and other ways, TRM1 110(1) may use granular health information and additional information from the transaction request to determine whether a service is likely to fail while performing processing for the transaction.

If TRM1 110(1) determines that S1 104(1) is likely to fail while performing processing for the transaction, then TRM1 110(1) may proceed to cause (block 208) the requested transaction to not be initiated. On the other hand, if TRM1 110(1) determines that S1 104(1) is not likely to fail while performing processing for the transaction, then TRM1 110(1) may proceed to access, from health service information 122(1), health information for the next service that is to be invoked in the transaction, which in the current example is S2 104(2). Using this health information, TRM1 110(1) may determine whether S2 104(2) is currently available. If S2 104(2) is not currently available, then TRM1 110(1) may predictively conclude that the overall transaction is likely to fail, and hence, may proceed to cause (block 208) the requested transaction to not be initiated. On the other hand, if TRM1 110(1) determines that S2 104(2) is currently available, then TRM1 110(1) may look deeper into the health information for S2 104(2) to determine whether S2 104(2) is likely to fail while performing processing for the transaction. TRM1 110(1) may make this determination in a manner similar to that described above in connection with S1 104(1). If TRM1 110(1) determines that S2 104(2) is likely to fail while performing processing for the transaction, then TRM1 110(1) may proceed to cause (block 208) the requested transaction to not be initiated.

However, if TRM1 110(1) determines that S2 104(2) is not likely to fail while performing processing for the transaction, then TRM1 110(1) may proceed to access, from health service information 122(1), health information for the next service that is to be invoked in the transaction, which in the current example is S3 104(3). Using this health information, TRM1 110(1) may determine whether S3 104(3) is currently available. If S3 104(3) is not currently available, then TRM1 110(1) may predictively conclude that the overall transaction is likely to fail, and hence, may proceed to cause (block 208) the requested transaction to not be initiated. On the other hand, if TRM1 110(1) determines that S3 104(3) is currently available, then TRM1 110(1) may look deeper into the health information for S3 104(3) to determine whether S3 104(3) is likely to fail while performing processing for the transaction. TRM1 110(1) may make this determination in a manner similar to that described above in connection with S1 104(1). If TRM1 110(1) determines that S3 104(3) is likely to fail while performing processing for the transaction, then TRM1 110(1) may proceed to cause (block 208) the requested transaction to not be initiated.

On the other hand, if TRM1 110(1) determines that S3 104(3) is not likely to fail while performing processing for the transaction, then TRM1 110(1) may proceed to access, from health service information 122(1), health information for the next service that is to be invoked in the transaction, which in the current example is S4 104(4), the final service in the transaction. Using this health information, TRM1 110(1) may determine whether S4 104(4) is currently available. If S4 104(4) is not currently available, then TRM1 110(1) may predictively conclude that the overall transaction is likely to fail, and hence, may proceed to cause (block 208) the requested transaction to not be initiated. On the other hand, if TRM1 110(1) determines that S4 104(4) is currently available, then TRM1 110(1) may look deeper into the health information for S4 104(4) to determine whether S4 104(4) is likely to fail while performing processing for the transaction. TRM1 110(1) may make this determination in a manner similar to that described above in connection with S1 104(1). If TRM1 110(1) determines that S4 104(4) is likely to fail while performing processing for the transaction, then TRM1 110(1) may proceed to cause (block 208) the requested transaction to not be initiated.

However, if TRM1 110(1) determines that S4 104(4) is not likely to fail while performing processing for the transaction (and since S4 104(4) is the final service in the requested transaction), TRM1 110(1) may predictively conclude that the overall transaction is likely to succeed. Put another way, TRM1 110(1) may predictively conclude that the overall transaction is not likely to fail. In such a case, TRM1 110(1) may proceed to initiate (block 210) the requested transaction. TRM1 110(1) may do so, for example, by forwarding the transaction request to the first service in the transaction which, in the current example, is S1 104(1).

Thereafter, S1 104(1) may perform whatever processing is required by the transaction, and then invoke S2 104(2) to continue the transaction. In turn, S2 104(2) performs whatever processing is required by the transaction, and then invokes S3 104(3). Likewise, S3 104(3) performs whatever processing is required by the transaction, and then invokes S4 104(4). Finally, S4 104(4) completes processing of the transaction, and returns a response to the requesting client 140.

In the manner described, a multi-service transaction may be initiated and carried out in accordance with one embodiment of the present invention.

### Automatic Generation of Transaction Information

In the sample operation described above, it is assumed that the transaction information 120(1) already includes information indicating which services are associated with the transaction type identifier extracted from the transaction request. In one embodiment, this may not always be the case. Rather, a transaction request may be received for a transaction type that is not already specified in the transaction information 120(1). In such a case, information may need to be dynamically generated and stored into the transaction information 120(1), 120(2) that indicates which services are associated with the new transaction type. In one embodiment, this is achieved through cooperation between the TRMs 110(1), 110(2) as transaction processing is carried out. In FIG. 1, a line is shown between TRM1 110(1) and TRM2 110(2) to indicate that the two components exchange information for this purpose. In practice, this communication is likely to be conducted over network 130 rather than via a direction connection.

Suppose for the sake of illustration that TRM1 110(1) receives from a client 140 via network 130 a request for a transaction. In response to this request, TRM1 110(1) extracts a transaction type identifier from the request. However, this transaction type identifier is not one that is specified in the transaction information 120(1); thus, TRM1 110(1) cannot determine, based upon the transaction information 120(1), all of the services that need to be invoked in order to complete the requested transaction. However, the request does specify which service is the first service that needs to be invoked in order to carry out the requested transaction. With this information, TRM1 110(1) can initiate the transaction by forwarding the transaction request to the first service. For the sake of example, it will be assumed that the first service is S1 104(1). In one embodiment, in addition to initiating the transaction, TRM1 110(1) also stores some information into the transaction information 120(1). This information includes the transaction type identifier for the requested transaction, and an indication that the first service invoked for this transaction type identifier is S1 104(1). TRM1 110(1) also provides this information to TRM2 110(2). In turn, TRM2 110(2) updates the transaction information 120(2) with this information; thus, both sets of transaction information 120(1), 120(2) now have information that includes the transaction type identifier for the requested transaction and an indication that the first service invoked for this transaction type identifier is S1 104(1). Thereafter, the TRMs 110(1), 110(2) track the progress of the transaction.

Suppose that after performing its processing, S1 104(1) invokes S2 104(2). In one embodiment, TRM1 110(1) monitors the activities of S1 104(1) and S2 104(2) and hence is aware of this invocation. Included in the invocation is the transaction type identifier for the requested transaction, information indicating the invoking service (S1104(1)), and information indicating the target service (S2 104(2)). Given the transaction type identifier, TRM1 110(1) is able to determine that this invocation is part of the requested transaction, and given the information indicating the invoking and target services, TRM1 110(1) is able to determine that the invocation is from S1 104(1) to S2 104(2). Based on this knowledge, TRM1 110(1) stores additional information into the transaction information 120(1) to indicate that, for the transaction type identifier for the requested transaction, S1 104(1) invokes S2 104(2) to further the transaction. TRM1 110(1) also provides this information to TRM2 110(2). In turn, TRM2 110(2) updates the transaction information 120(2) with this information; thus, both sets of transaction information 120(1), 120(2) now have information that includes the transaction type identifier for the requested transaction and an indication that services S1 104(1) and S2 104(2) are invoked, in that order, to further the requested transaction.

Suppose further that after performing its processing, S2 104(2) invokes S3 104(3). In one embodiment, TRM2 110(2) monitors the activities of S3 104(3) and S4 104(4) and hence is aware of this invocation. Included in the invocation is the transaction type identifier for the requested transaction, information indicating the invoking service (S2 104(2)), and information indicating the target service (S3 104(3)). Given the transaction type identifier, TRM2 110(2) is able to determine that this invocation is part of the requested transaction, and given the information indicating the invoking and target services, TRM2 110(2) is able to determine that the invocation is from S2 104(2) to S3 104(3). Based on this knowledge, TRM2 110(2) stores additional information into the transaction information 120(2) to indicate that, for the transaction type identifier for the requested transaction, S2 104(2) invokes S3 104(3) to further the transaction. TRM2 110(2) also provides this information to TRM1 110(1). In turn, TRM1 110(1) updates the transaction information 120(1) with this information; thus, both sets of transaction information 120(1), 120(2) now have information that includes the transaction type identifier for the requested transaction and an indication that services S1 104(1), S2 104(2), and S3 104(3) are invoked, in that order, to further the requested transaction.

Suppose further that after performing its processing, S3 104(3) completes the requested transaction and returns a response to the requesting client 140. Since this is not an invocation of another service 104, the TRMs 110(1), 110(2) make no further update to the transaction information 120(1), 120(2) for the transaction type identifier for the requested transaction; thus, the transaction information for the transaction type identifier is complete. This information may thereafter be used for subsequent transaction requests.

For example, suppose TRM1 110(1) receives another request to initiate a transaction. Suppose further that TRM1 110(1) extracts from the request a transaction type identifier that is the same as the transaction type identifier for which transaction information was just generated and stored. Based, at least in part, upon the newly stored information in the transaction information 120(1), TRM1 110(1) can determine that services S1 104(1), S2 104(2), and S3 104(3) need to be invoked, in that order, in order to complete the transaction. TRM1 110(1) may thereafter use this information, in the manner described previously, to determine whether to initiate the requested transaction.

### Hardware Overview

With reference to FIG. 3, there is shown a block diagram of a computer system that may be used to implement at least a portion of the present invention. Computer system 300 includes a bus 302 or other communication mechanism for communicating information, and one or more hardware processors 304 coupled with bus 302 for processing information. Hardware processor 304 may be, for example, a general purpose microprocessor.

Computer system 300 also includes a main memory 306, such as a random access memory (RAM) or other dynamic storage device, coupled to bus 302 for storing information and instructions to be executed by processor 304. Main memory 306 also may be used for storing temporary variables or other intermediate information during execution of instructions to be executed by processor 304. Such instructions, when stored in non-transitory storage media accessible to processor 304, render computer system 300 into a special-purpose machine that is customized to perform the operations specified in the instructions.

Computer system 300 further includes a read only memory (ROM) 308 or other static storage device coupled to bus 302 for storing static information and instructions for processor 304. A storage device 310, such as a magnetic disk, optical disk, or solid-state drive is provided and coupled to bus 302 for storing information and instructions.

Computer system 300 may be coupled via bus 302 to a display 312, such as a cathode ray tube (CRT), for displaying information to a computer user. An input device 314, including alphanumeric and other keys, is coupled to bus 302 for communicating information and command selections to processor 304. Another type of user input device is cursor control 316, such as a mouse, a trackball, or cursor direction keys for communicating direction information and command selections to processor 304 and for controlling cursor movement on display 312. This input device typically has two degrees of freedom in two axes, a first axis (e.g., x) and a second axis (e.g., y), that allows the device to specify positions in a plane.

Computer system 300 may implement the techniques and components (e.g. TRMs 110, health coordinators 108, sensors 106, services 104, etc.) described herein using customized hard-wired logic, one or more ASICs or FPGAs, firmware and/or program logic which in combination with the computer system causes or programs computer system 300 to be a special-purpose machine. According to one embodiment, the techniques disclosed herein for TRMs 110, health coordinators 108, sensors 106, and services 104 are performed by computer system 300 in response to processor 304 executing one or more sequences of one or more instructions contained in main memory 306. Such instructions may be read into main memory 306 from another storage medium, such as storage device 310. Execution of the sequences of instructions contained in main memory 306 causes processor 304 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 310. Volatile media includes dynamic memory, such as main memory 306. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 302. Transmission media can also take the form of acoustic or light waves, such as those generated during radio-wave and infra-red data communications.

Various forms of media may be involved in carrying one or more sequences of one or more instructions to processor 304 for execution. For example, the instructions may initially be carried on a magnetic disk or solid-state drive of a remote computer. The remote computer can load the instructions into its dynamic memory and send the instructions over a telephone line using a modem. A modem local to computer system 300 can receive the data on the telephone line and use an infra-red transmitter to convert the data to an infra-red signal. An infra-red detector can receive the data carried in the infra-red signal and appropriate circuitry can place the data on bus 302. Bus 302 carries the data to main memory 306, from which processor 304 retrieves and executes the instructions. The instructions received by main memory 306 may optionally be stored on storage device 310 either before or after execution by processor 304.

Computer system 300 also includes a communication interface 318 coupled to bus 302. Communication interface 318 provides a two-way data communication coupling to a network link 320 that is connected to a local network 322. For example, communication interface 318 may be an integrated services digital network (ISDN) card, cable modem, satellite modem, or a modem to provide a data communication connection to a corresponding type of telephone line. As another example, communication interface 318 may be a local area network (LAN) card to provide a data communication connection to a compatible LAN. Wireless links may also be implemented. In any such implementation, communication interface 318 sends and receives electrical, electromagnetic or optical signals that carry digital data streams representing various types of information.

Network link 320 typically provides data communication through one or more networks to other data devices. For example, network link 320 may provide a connection through local network 322 to a host computer 324 or to data equipment operated by an Internet Service Provider (ISP) 326. ISP 326 in turn provides data communication services through the world wide packet data communication network now commonly referred to as the “Internet” 328. Local network 322 and Internet 328 both use electrical, electromagnetic or optical signals that carry digital data streams. The signals through the various networks and the signals on network link 320 and through communication interface 318, which carry the digital data to and from computer system 300, are example forms of transmission media.

Computer system 300 can send messages and receive data, including program code, through the network(s), network link 320 and communication interface 318. In the Internet example, a server 330 might transmit a requested code for an application program through Internet 328, ISP 326, local network 322 and communication interface 318. The received code may be executed by processor 304 as it is received, and/or stored in storage device 310, or other non-volatile storage for later execution.

At this point, it should be noted that although the invention has been described with reference to specific embodiments, it should not be construed to be so limited. Various modifications may be made by those of ordinary skill in the art with the benefit of this disclosure without departing from the spirit of the invention. Thus, the invention should not be limited by the specific embodiments used to illustrate it but only by the scope of the issued claims.

What is claimed is:

1. A method comprising:
receiving a request to initiate a first transaction;
determining a set of services that need to be invoked in order to complete the first transaction, wherein the set of services comprises a plurality of services;
determining whether at least one of the services in the plurality of services is likely to be unable to complete processing needed to further the first transaction to completion; and
in response to a determination that at least one of the services in the plurality of services is likely to be unable to complete processing needed to further the first transaction to completion, causing the first transaction to not be initiated;
wherein the method is performed by one or more computer systems.

2. The method of claim 1, wherein determining the set of services that need to be invoked in order to complete the first transaction comprises:
extracting, from the request, a transaction type identifier for the first transaction;
accessing a set of transaction information that indicates which services are associated with which transaction type identifiers; and
obtaining, from the set of transaction information, a set of services associated with the transaction type identifier for the first transaction.

3. The method of claim 1, wherein the services in the plurality of services are invoked in a predetermined sequence, starting with a first service followed by one or more subsequent services, and wherein determining whether at least one of the services in the plurality of services is likely to be unable to complete processing needed to further the first transaction to completion comprises:
determining whether the first service is currently unavailable; and
in response to a determination that the first service is not currently unavailable, determining whether at least one of the one or more subsequent services is currently unavailable.

4. The method of claim 1, wherein the plurality of services comprises a particular service, and wherein determining whether at least one of the services in the plurality of services is likely to be unable to complete processing needed to further the first transaction to completion comprises:
accessing health information pertaining to the particular service, wherein the particular service is currently available; and
determining, based at least in part upon the health information, whether the particular service is likely to fail while performing processing for the first transaction.

5. The method of claim 4, further comprising:
receiving sensor information pertaining to one or more operational aspects of the particular service; and
processing the sensor information to derive the health information pertaining to the particular service.

6. The method of claim 1, wherein the plurality of services comprises a particular service, wherein the request comprises information indicating what processing is to be performed by the particular service for the first transaction, and wherein determining whether at least one of the services in the plurality of services is likely to be unable to complete processing needed to further the first transaction to completion comprises:
accessing health information pertaining to the particular service, wherein the particular service is currently available; and
determining, based at least in part upon the health information and the information indicating what processing is to be performed by the particular service for the first transaction, whether the particular service is likely to fail while performing processing for the first transaction.

7. The method of claim 1, wherein the services in the plurality of services are invoked in a predetermined sequence, starting with a first service followed by a second service followed by zero or more subsequent services, and wherein determining whether at least one of the services in the plurality of services is likely to be unable to complete processing needed to further the first transaction to completion comprises:
determining, based at least in part upon a first set of health information pertaining to the first service, whether the first service is likely to fail while performing processing for the first transaction, wherein the first service is currently available; and
in response to a determination that the first service is not likely to fail while performing processing for the first transaction, determining, based at least in part upon a second set of health information pertaining to the second service, whether the second service is likely to fail while performing processing for the first transaction.

8. The method of claim 1, further comprising:
receiving a request to initiate a second transaction, wherein prior to initiation of the second transaction, it is not known which set of services need to be invoked in order to complete the second transaction;
extracting, from the request to initiate the second transaction, a transaction type identifier for the second transaction;
initiating the second transaction; and
as the second transaction is conducted, storing transaction information indicating which services were invoked in the course of conducting the second transaction, wherein the transaction information is associated with the transaction type identifier for the second transaction.

9. The method of claim 8, further comprising:
receiving a request to initiate a third transaction, wherein the request to initiate the third transaction comprises a transaction type identifier that is the same as the transaction type identifier for the second transaction; and
determining, based at least in part upon the transaction information, which services need to be invoked in order to complete the third transaction.

10. The method of claim 1, wherein the plurality of services comprises a first service and a second service, wherein the first service is hosted on a first computer system and the second service is hosted on a second computer system, which is separate from the first computer system, wherein the method is performed by the first computer system, and wherein determining whether at least one of the services in the plurality of services is likely to be unable to complete processing needed to further the first transaction to completion comprises:
accessing health information pertaining to the second service; and
determining, based at least in part upon the health information, whether the second service is likely to fail while performing processing for the first transaction.

11. A computer system configured to perform the following operations:
receiving a request to initiate a first transaction;
determining a set of services that need to be invoked in order to complete the first transaction, wherein the set of services comprises a plurality of services;
determining whether at least one of the services in the plurality of services is likely to be unable to complete processing needed to further the first transaction to completion; and
in response to a determination that at least one of the services in the plurality of services is likely to be unable to complete processing needed to further the first transaction to completion, causing the first transaction to not be initiated.

12. The computer system of claim 11, wherein determining the set of services that need to be invoked in order to complete the first transaction comprises:
extracting, from the request, a transaction type identifier for the first transaction;
accessing a set of transaction information that indicates which services are associated with which transaction type identifiers; and
obtaining, from the set of transaction information, a set of services associated with the transaction type identifier for the first transaction.

13. The computer system of claim 11, wherein the services in the plurality of services are invoked in a predetermined sequence, starting with a first service followed by one or more subsequent services, and wherein determining whether at least one of the services in the plurality of services is likely to be unable to complete processing needed to further the first transaction to completion comprises:
determining whether the first service is currently unavailable; and
in response to a determination that the first service is not currently unavailable, determining whether at least one of the one or more subsequent services is currently unavailable.

14. The computer system of claim 11, wherein the plurality of services comprises a particular service, and wherein determining whether at least one of the services in the plurality of services is likely to be unable to complete processing needed to further the first transaction to completion comprises:
accessing health information pertaining to the particular service, wherein the particular service is currently available; and
determining, based at least in part upon the health information, whether the particular service is likely to fail while performing processing for the first transaction.

15. The computer system of claim 14, wherein the particular service is hosted on another computer system.

16. The computer system of claim 14, wherein the particular service is hosted on the computer system, and wherein the computer system is configured to perform the following additional operations:
monitoring operation of the particular service to generate sensor information pertaining to one or more operational aspects of the particular service; and
processing the sensor information to derive the health information pertaining to the particular service.

17. The computer system of claim 14, wherein the particular service is hosted on another computer system, and wherein the computer system is configured to perform the following additional operations:
receiving, from the other computer system, sensor information pertaining to one or more operational aspects of the particular service; and
processing the sensor information to derive the health information pertaining to the particular service.

18. The computer system of claim 11, wherein the plurality of services comprises a particular service, wherein the request comprises information indicating what processing is to be performed by the particular service for the first transaction, and wherein determining whether at least one of the services in the plurality of services is likely to be unable to complete processing needed to further the first transaction to completion comprises:
accessing health information pertaining to the particular service, wherein the particular service is currently available; and
determining, based at least in part upon the health information and the information indicating what processing is to be performed by the particular service for the first transaction, whether the particular service is likely to fail while performing processing for the first transaction.

19. The computer system of claim 11, wherein the services in the plurality of services are invoked in a predetermined sequence, starting with a first service followed by a second service followed by zero or more subsequent services, and wherein determining whether at least one of the services in the plurality of services is likely to be unable to complete processing needed to further the first transaction to completion comprises:
determining, based at least in part upon a first set of health information pertaining to the first service, whether the first service is likely to fail while performing processing for the first transaction, wherein the first service is currently available; and
in response to a determination that the first service is not likely to fail while performing processing for the first transaction, determining, based at least in part upon a second set of health information pertaining to the second service, whether the second service is likely to fail while performing processing for the first transaction.

20. The computer system of claim 11, wherein the computer system is configured to perform the following additional operations:
receiving a request to initiate a second transaction, wherein prior to initiation of the second transaction, it is not known which set of services need to be invoked in order to complete the second transaction;
extracting, from the request to initiate the second transaction, a transaction type identifier for the second transaction;
initiating the second transaction; and
as the second transaction is conducted, storing transaction information indicating which services were invoked in the course of conducting the second transaction, wherein the transaction information is associated with the transaction type identifier for the second transaction.

21. The computer system of claim 20, wherein the computer system is configured to perform the following additional operations:
receiving a request to initiate a third transaction, wherein the request to initiate the third transaction comprises a transaction type identifier that is the same as the transaction type identifier for the second transaction; and
determining, based at least in part upon the transaction information, which services need to be invoked in order to complete the third transaction.

22. The computer system of claim 11, wherein the plurality of services comprises a first service that is hosted on the computer system and a second service that is hosted on another computer system, and wherein determining whether at least one of the services in the plurality of services is likely to be unable to complete processing needed to further the first transaction to completion comprises:
determining whether the first service is likely to fail while performing processing for the first transaction; and
determining whether the second service is likely to fail while performing processing for the first transaction.

23. A computer readable storage medium comprising instructions which, when executed by one or more processors, cause the one or more processors to perform the following operations:
receiving a request to initiate a first transaction;
determining a set of services that need to be invoked in order to complete the first transaction, wherein the set of services comprises a plurality of services;
determining whether at least one of the services in the plurality of services is likely to be unable to complete processing needed to further the first transaction to completion; and
in response to a determination that at least one of the services in the plurality of services is likely to be unable to complete processing needed to further the first transaction to completion, causing the first transaction to not be initiated.

24. The computer readable storage medium of claim 23, wherein the plurality of services comprises a particular service, and wherein determining whether at least one of the services in the plurality of services is likely to be unable to complete processing needed to further the first transaction to completion comprises:
accessing health information pertaining to the particular service, wherein the particular service is currently available; and
determining, based at least in part upon the health information, whether the particular service is likely to fail while performing processing for the first transaction.

25. The computer readable storage medium of claim 23, wherein the plurality of services comprises a particular service, wherein the request comprises information indicating what processing is to be performed by the particular service for the first transaction, and wherein determining whether at least one of the services in the plurality of services is likely to be unable to complete processing needed to further the first transaction to completion comprises:
accessing health information pertaining to the particular service, wherein the particular service is currently available; and
determining, based at least in part upon the health information and the information indicating what processing is to be performed by the particular service for the first transaction, whether the particular service is likely to fail while performing processing for the first transaction.

26. The computer readable storage medium of claim 23, wherein the instructions, when executed by the one or more processors, cause the one or more processors to perform the following additional operations:
receiving a request to initiate a second transaction, wherein prior to initiation of the second transaction, it is not known which set of services need to be invoked in order to complete the second transaction;
extracting, from the request to initiate the second transaction, a transaction type identifier for the second transaction;
initiating the second transaction; and
as the second transaction is conducted, storing transaction information indicating which services were invoked in the course of conducting the second transaction, wherein the transaction information is associated with the transaction type identifier for the second transaction.
